(19) United States
(12) Patent Application Publication
(10) Pub. No.: US 2009/0158552 A1
(43) Pub. Date: Jun. 25, 2009

(54) FLIP-TYPE ELECTRONIC APPARATUS

(75) Inventors: SHI-KUN GUO, Shenzhen City (CN); JIN-FENG LIU, Shenzhen City (CN); QIA-KAI XIE, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/239,827

(22) Filed: Sep. 29, 2008

(30) Foreign Application Priority Data
Dec. 21, 2007 (CN) 200710203347.6

(51) Int. Cl. E05F 11/08

(52) U.S. Cl. 16/65

(57) ABSTRACT

A flip-type electronic apparatus includes a base panel, a cover, and a latch mechanism pivotably fastening the cover to the base panel. At least one post extends from the cover into the base panel. The latch mechanism includes a button mounted on the base panel, and a sliding bar received in the base panel. At least one limiting portion is formed on one lateral side of the sliding bar receiving the post of the cover. The sliding bar forms a pair of inclined operating surfaces, and the button forms at least one inclined actuating surface abutting at least one of the pair of inclined operating surface. When the button is pressed, the actuating surfaces pushes the operating surfaces to cause the sliding bar to move away from the button, and thus the post is released from the limiting portion for opening the cover of the electronic apparatus.

### BACKGROUND

1. Field of the Disclosure

The disclosure generally relates to electronic apparatuses, and particularly to a flip-type electronic apparatus.

2. Description of Related Art

With the continuing development of electronic technology, flip type electronic apparatuses, such as notebook computers and portable digital video disk (DVD) players, have been widely used due to their convenience and practicality.

A DVD player generally includes a main body and a lid. The lid is pivotably connected with the main body and rotates, with respect to the main body, between an opened position and a closed position. When the lid is at the opened position, the lid is away from the main body. When the lid is at the closed position, the lid is in contact with and fastened to the main body by a fastening assembly. The fastening assembly typically includes a pair of latch members installed at opposite side edges of the lid, and a pair of latch grooves defined in the main body corresponding to the pair of latch members. Two slide knobs for operating the latch members are formed on the lip adjacent to the latch members. In order to open the lip from the main body, the two slide knobs slid in one direction to release the respective latch members from corresponding latch grooves. Both slide knobs installed on opposite sides of the lip must be manually and simultaneously operated, which is burdensome and inconvenient.

For the foregoing reasons, therefore, there is a need in the art for a flip-type electronic apparatuses which overcomes the above-mentioned problems.

### SUMMARY

According to an exemplary embodiment, a flip-type electronic apparatus includes a base panel and a cover being pivotably connected to the base panel. At least one post extends from the cover into the base panel. A latch mechanism is provided to fasten the cover to the base panel. The latch mechanism includes a button mounted on the base panel, and a sliding bar received in the base panel and movably connected to the base panel. At least one limiting portion is formed on one lateral side of the sliding bar for receiving the at least one post of the cover. The sliding bar forms a pair of inclined operating surfaces, and the button forms at least one inclined actuating surface abutting at least one of the pair of inclined operating surface of the sliding bar. When the button is pressed, the actuating surfaces of the button pushes the operating surfaces of the sliding bar to cause the sliding bar to move away from the button, and thus the at least one post of the cover is released from the limiting portion of the sliding bar for opening the cover of the electronic apparatus.

Other advantages and novel features of the disclosure will be drawn from the following detailed description of the exemplary embodiments of the disclosure with attached drawings.

### BRIEF DESCRIPTION OF THE DRAWINGS

FIG. 1 is an isometric view of a flip-type electronic apparatus at a closed position according to an exemplary embodiment.

FIG. 2 is an exploded view of the flip-type electronic apparatus of FIG. 1.

FIG. 3 is an enlarged view of a circled portion III of FIG. 2.

FIG. 4 is an isometric, exploded view of a latch mechanism of the flip-type electronic apparatus of FIG. 2, view from a bottom aspect.

FIG. 5 is an enlarged view of a button of the latch mechanism of FIG. 4.

FIG. 6 is an assembled view of the latch mechanism of FIG. 4.

FIG. 7 is a cross-sectional view of the electronic apparatus of FIG. 1 take along line VII-VII.

### DETAILED DESCRIPTION OF THE EMBODIMENTS

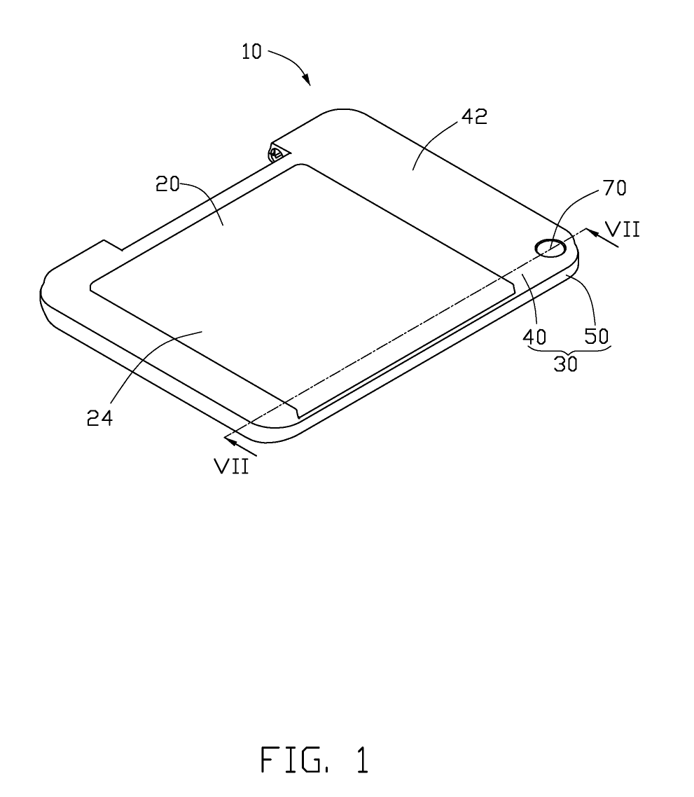

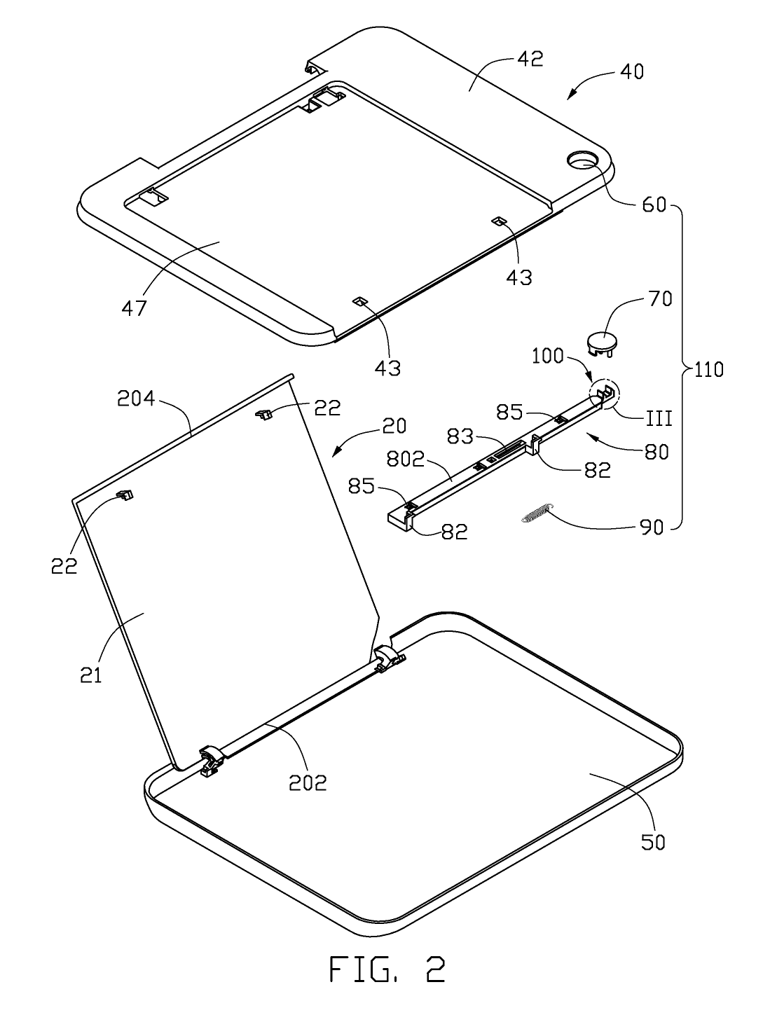

Referring to FIGS. 1 and 2, a flip-type electronic apparatus 10 in accordance with an exemplary embodiment is shown. The electronic apparatus 10 can be a portable digital video disk player, a notebook computer, or a game player. The electronic apparatus 10 is at a closed position, and includes a cover 20, a base panel 30, and a latch mechanism 110 holding the cover 20 to the base panel 30.

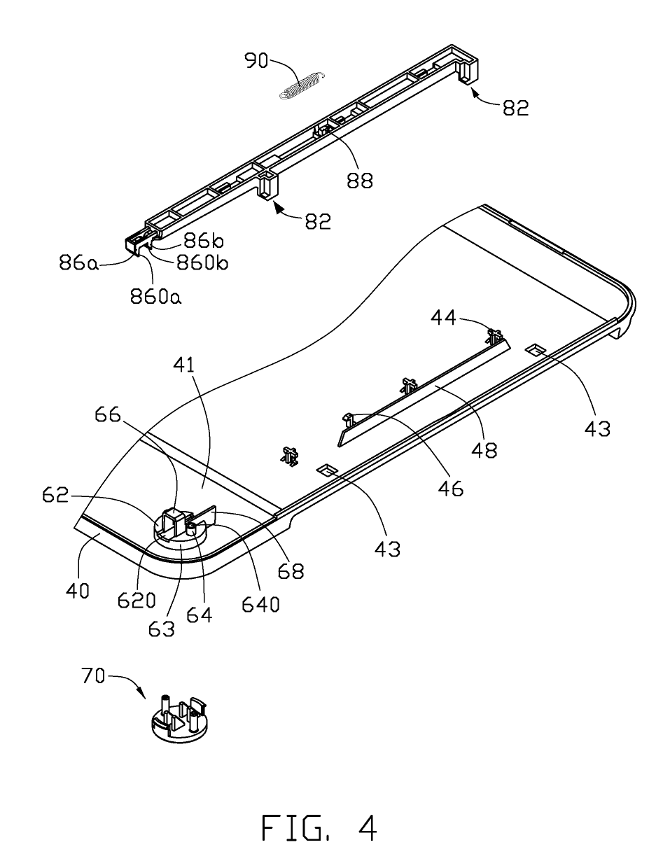

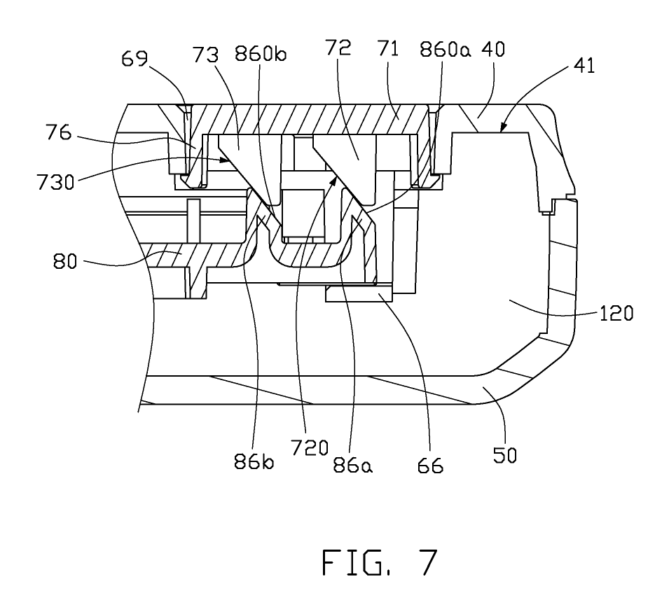

Referring to FIG. 4 and FIG. 7 simultaneously, the base panel 30 includes a lower base 50 and an upper base 40 detachably assembled to the lower base 50. The lower base 50 and the upper base 40 cooperatively define a space 120 therebetween for receiving the latch mechanism 110. The upper base 40 includes an inner surface 41 facing the lower base 50, and an outer surface 42 opposite to the inner surface 41. A concave portion 47 is formed in a middle of the outer surface 42 of the upper base 40. The cover 20 is received in the concave portion 47 of the upper base 40. An outer surface 24 of the cover 20 is coplanar with the outer surface 42 of the upper base 40 of the base panel 30. The cover 20 includes a rear side 202 pivotally engaged with a rear side of the base panel 30, and a front side 204 opposite to the rear side 202. Thus the cover 20 is rotatable relative to the rear side 22 to be in the closed position and an open position. A pair of posts 22 extend from an inner surface 21 of the cover 20 near the front side 204. A pair of through holes 43 are defined in the upper base 40 to receive the posts 22 of the cover 20 therethrough. Each through hole 43 has a size a little larger than that of the corresponding post 22.

A baffle 48 is formed on the inner surface 41 of the upper base 40 near the through holes 43. The baffle 48 is parallel to a line defined between the through holes 43. A length of the baffle 48 is smaller than a distance between the two through holes 43, and the baffle 48 is located between the two through holes 43. Three fixing poles 44 extend perpendicularly from the inner surface 41 of the upper base 40. The three fixing poles 44 are linearly arranged, and are evenly spaced from each other. A hook 46 is formed between two left neighboring fixing poles 44, and is collinear with the fixing poles 44. An imaginary line joining the fixing poles 44 and the hook 46 is parallel to the baffle 48.

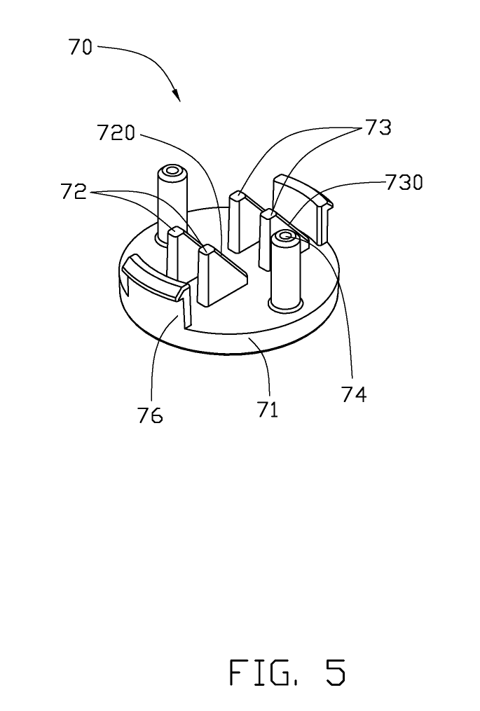

Referring to FIG. 2 again, the latch mechanism 110 includes a button 70, a sliding bar 80, and a spring 90. Referring to FIGS. 4 and 5, the button 70 includes a circular-shaped button body 71, a pair of barbs 76, and a pair of pillars 74. The barbs 76 and the pillars 74 extend upwardly from a periphery of the button body 71, and are alternating along a circumferential direction of the button body 71. Four blocks 72, 73 extend from the button body 71. The four blocks 72, 73 are arranged in two rows by two lines around a center of the button body 71. From a front view, each of the blocks 72, 73 has a shape of an isosceles right triangle, and includes a vertical left side perpendicular to the button body 71 and a slanted right side forming an inclined actuating surface 720, 730 thereon. The two actuating surfaces 720 of the left line blocks 72 are coplanar with each other. The two actuating surfaces 730 of the right line blocks 73 are coplanar with each other. The two actuating surfaces 720 of the left line blocks 72 are parallel to the two actuating surfaces 730 of the right line blocks 73.

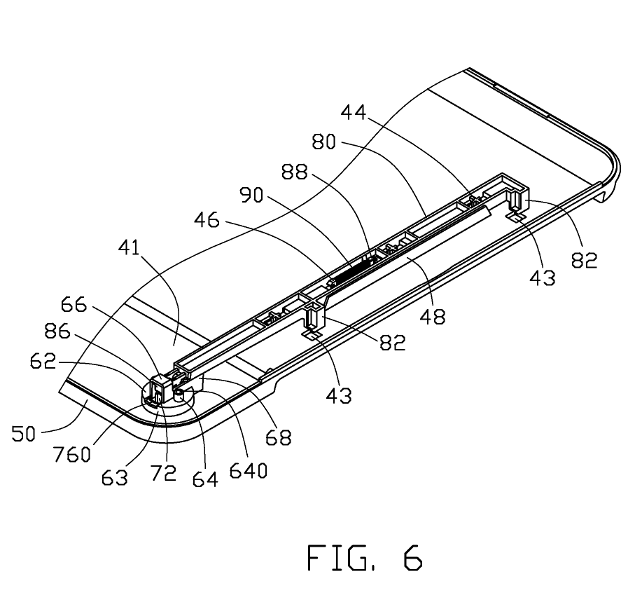

Referring to FIG. 4, a supporting portion 60 (FIG. 2) is a recess formed in the outer surface 42 of the upper base 40 for fixing the button 70 thereon. The supporting portion 60 includes an annular sidewall 63 extending from the upper base 40 and a circular basewall 62 enclosing a top side of the sidewall 63. An operating hole 69 (as shown in FIG. 7) is thus defined in the supporting portion 60 receiving the button body 71 therein. A center of the basewall 62 is approximately collinear with the three fixing poles 44. A notch 620 is defined in the basewall 62 and extends through the basewall 62 along the line defined by the three fixing poles 44. A pair of cylinders 64 extend from opposite sides of the notch 620 of the basewall 62, and each cylinder 64 defines a receiving hole 640. Also referring to FIG. 6, the pillars 74 are received in the receiving holes 640 of the cylinders 64, and the barbs 76 extend through the notch 620 of the basewall 62 to engage with the sidewall 63 of the supporting portion 60. Thus the button 70 arranged in the supporting portion 60 is kept from rotating and coming loose. The blocks 72, 73 extend through the notch 620 with the actuating surfaces 720, 730 exposed to outside of the basewall 62. A U-shaped bridge 66 extends upwardly from the basewall 62 and interconnects opposite sides of the notch 620. The bridge 66 hangs over the blocks 72, 73. A sheet 68 extends from a front side of the notch 620 of the basewall 62. The sheet 68 is coplanar with the baffle 48 of the upper base 40.

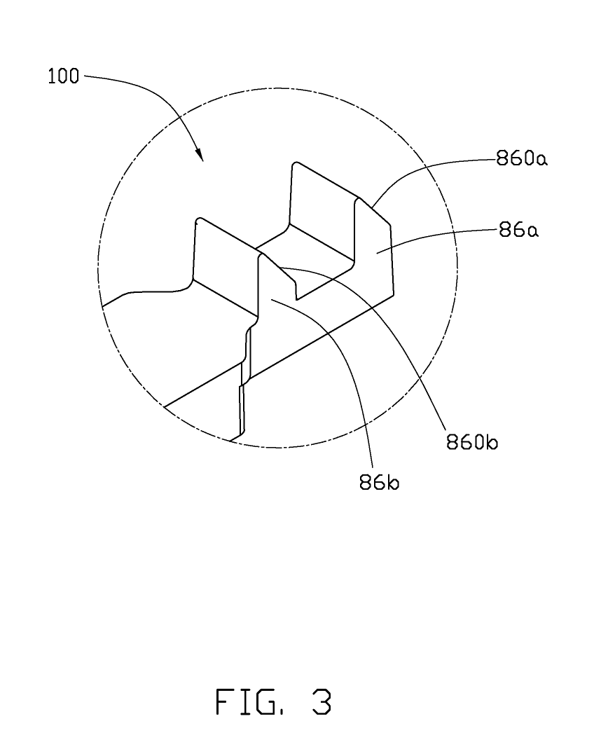

Referring to FIG. 2, the sliding bar 80 includes a main bar 802, and two limiting portions 82 extend outwardly from a front side of the main bar 802 corresponding to the posts 22 of the cover 20. The main bar 802 has a strip shape, and defines three T-shaped sliding grooves 85 therethrough corresponding to the fixing poles 44 of the upper base 40. Each respective sliding groove 85 is used to receive a respective fixing pole 44 of the upper base 40. The main bar 802 further includes an elongated groove 83 located between the two right most sliding grooves 85 (the two rightmost sliding grooves 85 of FIG. 2 can be seen to coincide with the two leftmost fixing poles 44 in FIG. 6 because of the orientation of the figure). The elongated groove 83 is configured for receiving the spring 90. An orienting portion 88 (shown in FIG. 4) extends from the main bar 802 at a position adjacent to the elongated groove 83. In addition, referring to FIGS. 2-3, the main bar 802 forms an operating portion 100 at a right end (left end in FIGS. 4 and 6) thereof. The operating portion 100 includes a first tooth 86a and a second tooth 86b extending perpendicularly from longitudinal surface of the bar 802. The first and second teeth 86a, 86b are spaced apart from each other, and each tooth forms an inclined operating surface 860a, 860b at a right side thereof. The operating surfaces 860a, 860b are parallel to each other, and are configured for abutting against the actuating surfaces 720, 730 of the blocks 72, 73 of the button 70.

Referring to FIG. 6, during assembly, the button 70 is fixed to the supporting portion 60 of the upper base 40. The sliding bar 80 is fixedly to the upper base 40 with the operating portion 100 extending into the bridge 66 of the supporting portion 60. The operating surfaces 860a, 860b of the operating portion 100 of the sliding bar 80 abut the actuating surfaces 720, 730 of the blocks 72, 73 of the button 70, i.e., the two actuating surfaces 720 of the left line blocks 72 abut the operating surface 860a of the first tooth 86a, and the two actuating surfaces 730 of the right line blocks 73 abut the operating surface 860b of the second tooth 86b. Meanwhile, each fixing pole 44 of the upper base 40 is aligned with and inserted into the corresponding sliding grooves 85 of the sliding bar 80. The hook 46 of the upper base 40 is aligned with and inserted into the elongated groove 83 of the sliding bar 80. The hook 46 and the orienting portion 88 are located at two opposite sides of the elongated groove 83. The spring 90 slides in the elongated groove 83 along a direction towards the button 70 with a left side engaged with the hook 46 of the upper base 40, and a right side engaged with the orienting portion 88 of the sliding bar 80. Thus the spring 90 movably fastens the sliding bar 80 onto the upper base 40 of the base panel 30. The board 68 and the baffle 48 abut the front side of the sliding bar 80 to limit movement of the sliding bar 80.

FIG. 7 shows the cover 20 at the closed position. The cover 20 is received in the concave portion 47 of the upper base 40, and the upper base 40 is assembled to the lower base 50. The latch mechanism 110 is arrangement in the space 120 of the base panel 30. The posts 22 of the cover 20 extend through the through holes 43 of the upper base 40, and engage with the limiting portions 82 of the latch mechanism 110. At this time, the spring 90 is at a normal state. When the button 70 is pressed to open the cover 20, the actuating surfaces 720, 730 of the button 70 cooperate with the operating surfaces 860a, 860b of the sliding bar 80, thus driving/pushing the sliding bar 80 to slide along a direction away from the button 70. At this time, the spring 90 becomes stretched, and the limiting portions 82 of the sliding bar 80 slide together with the sliding bar 80 to disengage from the posts 22 of the cover 20. Accordingly, the cover 20 can be opened. When the button 70 is released (no longer pressed), the sliding bar 80 slides towards the button 70 and back to the previous position under a resilient force generated by the spring 90. Because the sliding bar 80 is moved by the actuating surfaces 720, 730 of the button 70 and the operating surfaces 860a, 860b of the sliding bar 80, thus only the button 70 needs to be pressed to open the cover 20 of the electronic apparatus 10, which is simple and convenient. In addition, the button 70 forms four actuating surfaces 720, 730, when any portion of the button body 71 is pressed, the actuating surface 720, 730 drives the sliding bar 80 to move.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A flip-type electronic apparatus, comprising:
a base panel;
a cover being pivotably connected to the base panel, at least one post extending from the cover into the base panel; and
a latch mechanism comprising a button mounted on the base panel, and a sliding bar received in the base panel and movably connected to the base panel, at least one limiting portion formed on one lateral side of the sliding bar for receiving the at least one post of the cover, the sliding bar forming a pair of inclined operating surfaces, and the button forming at least one inclined actuating surface abutting at least one of the pair of inclined operating surface of the sliding bar, wherein when the button is pressed, the actuating surfaces of the button pushes the operating surfaces of the sliding bar to cause the sliding bar to move away from the button, and thus the at least one post of the cover is released from the limiting portion of the sliding bar for opening the cover of the electronic apparatus.

2. The electronic apparatus of claim 1, wherein the at least one inclined actuation surface of the button is a pair of inclined actuating surface and the pair of inclined actuating surface abuts the pair of inclined operating surface of the sliding bar respectively.

3. The electronic apparatus of claim 1, wherein the pair of inclined operating surfaces of the sliding bar are parallel to each other.

4. The electronic apparatus of claim 1, wherein a supporting portion is formed in a recess in the base panel, the supporting portion comprising a sidewall and a basewall, an operating hole being defined between the basewall and the sidewall for receiving the button, a notch being defined in the basewall, the actuating surfaces of the button extending through the notch of the basewall.

5. The electronic apparatus of claim 4, wherein at least one cylinder extends from the basewall of the supporting portion, the button comprising at least one pillar extending into the at least one cylinder of the supporting portion.

6. The electronic apparatus of claim 4, wherein a pair of barbs extend from the button through the notch of the supporting portion, and engage with the sidewall of the supporting portion to assemble the button to the base panel.

7. The electronic apparatus of claim 5, wherein a board extends from the supporting portion and abuts the sliding bard to limit movement of the sliding barb.

8. A latch mechanism of a flip-type electronic device for fastening a cover to a base panel of flip-type electronic device, comprising:
a button comprising a button body, and two groups of blocks extending from the button body, each block forming an inclined actuating surface;
a sliding bar forming a pair of inclined operating surfaces, each operating surface abutting the inclined actuating surface of one of the groups of blocks of the button;
at least one limiting portion formed on one lateral side of the sliding bar, the at least one limiting portion being configured for engaging with a fixing portion of the cover; and
a spring being configured for movably connecting the sliding bar to the base panel of the electronic device;
wherein when the button is pressed, the actuating surfaces of the button push the operating surfaces of the sliding bar to cause the sliding bar to move away from the button, and thus the fixing portion of the cover can be released from the limiting portion of the sliding bar for opening the cover of the electronic apparatus.

9. The latch mechanism of claim 8, wherein the each groups of block of the button includes two parallel blocks, each block forming an inclined actuating surface abutting the corresponding operating surface of the sliding bar.

10. The latch mechanism of claim 8, wherein the pair of inclined operating surfaces of the sliding bar are parallel to each other.

11. The latch mechanism of claim 8, further comprising a supporting portion having a basewall and a sidewall surrounding the basewall, an operating space being defined between the basewall and the sidewall for receiving the button body of the button therein.

12. The latch mechanism of claim 1, wherein a notch is defined in the basewall of the supporting portion, the blocks of the button extending through the notch of the basewall to contact the operating surfaces of the sliding barb.

13. The latch mechanism of claim 12, wherein a pair of barbs extend from the button body through the notch of the supporting portion, and engage with the sidewall of the supporting portion to assemble the button to the base panel.

14. The latch mechanism of claim 12, wherein a board extends from the supporting portion and abuts the sliding bard to limit movement of the sliding barb.

15. The latch mechanism of claim 12, wherein at least one cylinder extends from the basewall of the supporting portion, the button further comprising at least one pillar extending into the at least one cylinder of the supporting portion.
